(19) United States
(12) Patent Application Publication
(10) Pub. No.: US 2002/0072940 A1
(43) Pub. Date: Jun. 13, 2002

(54) System and method for automatic optimizing and issuance of prioritized reservations

(76) Inventor: Steven J. Keough, St. Paul, MN (US)

Correspondence Address: FREDRIKSON & BYRON P.A., 1100 INTERNATIONAL CENTRE, 900 SECOND AVENUE SOUTH, MINNEAPOLIS, MN, 55402

(21) Appl. No.: 09/966,549

(22) Filed: Sep. 26, 2001

Related U.S. Application Data
(60) Provisional application No. 60/235,774, filed on Sep. 26, 2000.

(51) Int. Cl. G06F 17/60

(52) U.S. Cl. 705/5

(57) ABSTRACT

A system for automatic optimizing and rapid booking of reservations for services. The system includes a reservation data sorter for receiving and sorting electronic data signals comprising information describing service availability for selected services from service providers. Also included is a communication component for allowing a user of the system to access the system and for the reservation data sorter to communicate with the user. A comparison component is provided for comparing the needs of a user accessing the system with the availability of the service to achieve an optimum, location-dependent reservation preference at any time the user communicates with the system.

### FIELD OF THE INVENTION

The invention relates to the field of online data management, including acquisition of services automatically.

### BACKGROUND OF THE INVENTION

Millions of travelers require hotel, automobile and other reservations prior to or during their travels. Moreover, needs exist to change reservations and to respond to new itinerary demands while traveling. Often, particularly in areas where high volumes of travelers exist, such as major cities and metropolitan areas, such travelers cannot obtain a hotel or similar reservation without extensive effort. Although rooms may exist, travelers may not be able to locate any available service for their need. Accordingly a new system to facilitate reservations is needed.

### SUMMARY OF THE INVENTION

The invention relates to a system for constant monitoring, optimizing and instant booking of reservations for services. Elements or components of the invention include: reservation data sorter means for receiving and sorting electronic data signals comprising information describing service availability for selected services; communication means for allowing a user of the system to access the system and for the reservation data sorter means to communicate with the user; and comparison means for comparing the needs of a user accessing the system with the availability of the service in order to achieve an optimum reservation preference at any time the user communicates with the system.

Another embodiment of the invention includes a data processing system executing an application program and containing a database used by the application program. The data processing system comprises CPU means for processing the application program and memory means for storing and deleting rapidly changing data for access by the application program. The memory means comprises a data structure stored in said memory means, with the data structure including information resident in a database used by the application program and including at least one identifying characteristics data file set stored in the memory means. Each of the data file sets contain information unique to a specific user. At least one preference data file set is stored in the memory means, and each of the data file sets contains information relating to service preferences of a specific user. The memory means also includes a plurality of data files containing constantly updated service availability data from a plurality of service providers. In this embodiment of the invention the data structure allows rapid access to the preference data file and the service availability data files to conduct comparison operations with at least one identifying data file set.

Another embodiment of the invention includes a memory for storing and deleting rapidly changing data for access by an application program being executed on a data processing sub-system. The memory comprises a data structure stored in said memory, at least one identifying characteristics data file set stored in the memory, at least one preference data file set stored in the memory, and a plurality of data files containing constantly updated service availability data from a plurality of service providers.

Another embodiment of the invention includes a method of doing business comprising a remote data sorter for constantly tracking and providing instant service reservations upon user demand. The method comprises the steps of: providing reservation data sorter means for receiving and sorting electronic data signals comprising information describing service availability for selected services; entering data transmission and handling agreements to receive the electronic data signals from the service providers and to allow instant reservations services and constant updating of the data transmitted; configuring communication means for allowing a user of the system to access the system via telephone and for the reservation data sorter means to communicate with the user; and providing comparison means for comparing the needs of a user accessing the system with the availability of the needed service in order to achieve an optimum reservation preference at any time the user communicates with the system and to communicate the optimum reservation preference to the user during the same telephone call that was initiated by the user.

Another embodiment of the invention includes bidding means cooperating with at least the reservation data sorter means for bidding for services initially not available from a service provider. This allows the user to receive optimized reservations by bidding to a pre-selected level for services made available subject to bidding operations. The system may further include alerts to the user, in various forms, regarding the bidding operation.

### BRIEF DESCRIPTION OF THE DRAWINGS

FIG. 1 is a schematic diagram of the information flow within the systems and methods of the invention.

FIG. 2 is a schematic diagram of the information flow within the systems and methods of the invention.

FIG. 3 is a schematic flow diagram of the method of information flow within the systems and methods of the invention.

### DETAILED DESCRIPTION OF THE INVENTION

A business method and system of reservations is needed to overcome the extensive problem of people or systems wasting extensive amounts of time awaiting fulfillment of service requests. In one example, travelers represent a class of service requestor. In this example a traveler may be unable to obtain a room reservation, or other travel related service reservation when desired. Indeed, every day there are millions of business people who try to alter or obtain a reservation within only a very short amount of time and are unable to do so or whom must wait excessively while existing systems attempt to meet the person's need. This is due to unavailability of the services they need at the moment they inquire, or due to lack of knowledge of the services which may be available and which could match the need of the traveler. Moreover, it is often necessary to navigate among numerous service providers-expending considerable time and effort in the process. It is recognized that numerous systems, methods, and patents likely exist for reservation systems. However, it is believed that none have identified the methods and technology herein disclosed, and only here is the recognition of the problem accompanied for the first time by a dramatic solution of various embodiments.

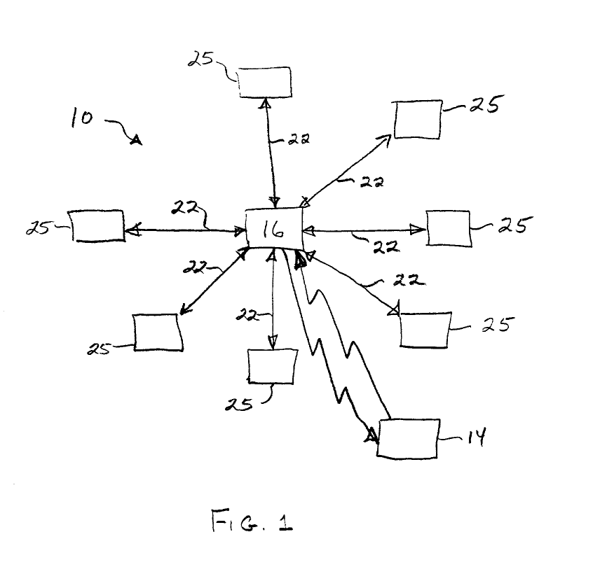

FIG. 1 illustrates a first embodiment of an invention to facilitate ease of access of a traveler to service needs by providing means for automatically sorting and customizing reservations and service information. System 10 provides communication means 14 for communicating to reservation data sorter 16, which may be either a centralized or distributed architecture server means for receiving, retaining and/or managing reservation data. In one embodiment, a distributed architecture may utilize hard drives or servers of enrollees in a service program related to this system, or may utilize other storage and processing media. Communication means 14 may include a variety of devices such as but not limited to cellular or other phones, handheld devices having communications capabilities such as handheld personal computers (HPCs), personal digital assistants (PDAs) and the like, and computers such as personal, desktop, laptop or others.

In one example, the traveler or user of the system uses their communication means 14 to place a single query, email, or call 18 (collectively this step is referred to herein as a “call 18” without limitation to the type of medium used) to data sorter 16 when a service or reservation is needed. Online queries or automatic routing may connect the user to the correct option for the service needed, e.g. type of service and dates or times. The user may already be an enrollee or registrant for the service, in which case the user's preferences may have already been registered and automatically tracked—awaiting an actual user request. Alternatively, a new member or preference may be entered with a quick entry or a more thorough entry. In any of the above options, after the user has placed the call 18, the user is instantly provided with a reservation or other confirming number for the service that was reserved during that communication, i.e., a reservation number is provided to the user via the data sorter 16 and communication means 14 which facilitates calls, transmissions or data signals 21 back to the user to provide the reservation or confirmation number in virtual real time. A routing system within communication means 14 may be optionally used to store the reservation or confirmation data in a specified data file for easy retrieval. In one embodiment, the routing mechanisms allow automatic placement of the reservation data in a travel folder, chronological or schedule folder as is commonly used, or a data storage location appropriate to the specific service reserved. It is recognized that a pager or other personal digital device capable of receiving such a signal is included herein as well.

In one embodiment, a cell phone capable of establishing precise relational locations and distances to the desired service is utilized with the invention herein. Indeed, phones or other communication means for receiving and transmitting data using this invention may utilize one or more of various standards or protocols. These include but are not limited to Wireless Application Protocol (WAP), the well-known ISDN and GSM standards, the General Packet Radio Services (GPRS), the Universal Mobile Telecommunications Systems (UMTS) or other variants thereof. Different communication means may also have one or more or various different application and operating systems.

In one embodiment, system 10 relies on a high volume or streams of data 22 that provide signals to reservation data sorter 16, which then maintains a constant update of availability of one or more services. These services are also rapidly prioritizable in order to find best matches with the needs of various users. As the availability of the services change, which is likely to be at all times, then the data is automatically updated. However, in view of the data being readily prioritized or otherwise coded for proper matching according to user preferences or profiles, the system allows for instant access to accurate information while minimizing unnecessary processing operations.

Referring to FIGS. 1-3, at the moment the user communicates with system 10, the data sorter 16 conducts a rapid best-fit analysis using a comparison subsystem 33, such as by using automatic software-based steps to compare and rate the available services 35 by location with the location, or designated location, of the user to obtain the optimal service according to the particular user preferences or pre-sets, shown schematically within user needs and location database 38. The user may choose to allow an automatic acceptance of a service reservation or may chose to conduct an accept/reject step or steps with the data sorter prior to accepting a proposed reservation. In either option, once the data sorter is authorized to make a best-fit match and to obtain a reservation, then system 10 communicates a structured signal in the form of acceptance 42 to the service provider 25 and user 16 of the service that is consistent with the best-fit analysis or algorithm. In one embodiment, each data stream or signal advising of the availability of a service option (which is coming from a service provider) is bundled or rapidly linkable with a reservation number or similar unique identifier (for example, a “source code” identifying the source of the service) that allows instantaneous acceptance and verification of the reservation and corresponding identifier to the user. In one example, a service provider generated signal identifying the availability of a certain hotel room type may have an embedded reservation number or numbers. In another example, the service provider generated signal identifies a specific room and includes one or more reservation identifiers to enable instant acceptance of that room by a user call 18. It is noted that this system allows for more precise scheduling of services, and even improved or more specific user preferences to be accommodated instantaneously.

In another embodiment, a network-enabled system includes a server computer hosting unique data transmitted from the remote users and service providers. The system also includes a user communication device providing access to the server having a plurality of data matches for a preference set of services desired by the user. The server computer provides a user interface whereby the plurality of users are authenticated prior to accessing the matched data; which is also referred to as an optimum reservation preference. During the constantly updating processes of matching the dynamic changing service availabilities with the user preference set of services, the system creates updated user file elements or data strings for selection when a new location of the user is activated by an active communication from the user, which in turn generates a location signal. It is recognized that the data structure and manipulation may vary according to the medium which is used to transmit information such as optimized reservation preferences, registration source codes, and the like. Indeed, various network forms may be used in this invention, i.e. private radio, cellular phone, Internet, etc.

Therefor, system 10 creates an online, constantly updated and accessible, data management system for allowing packaged or specialized signals to be rapidly and remotely accessed either through use of wired or wireless means. Following user access to system 10, a prompt of a best fit for a service need selects the best-fit data for that user and user's location (or interjected desired location) and communicates the matched service to the user, preferably along with a confirmation that the service is then reserved for the user.

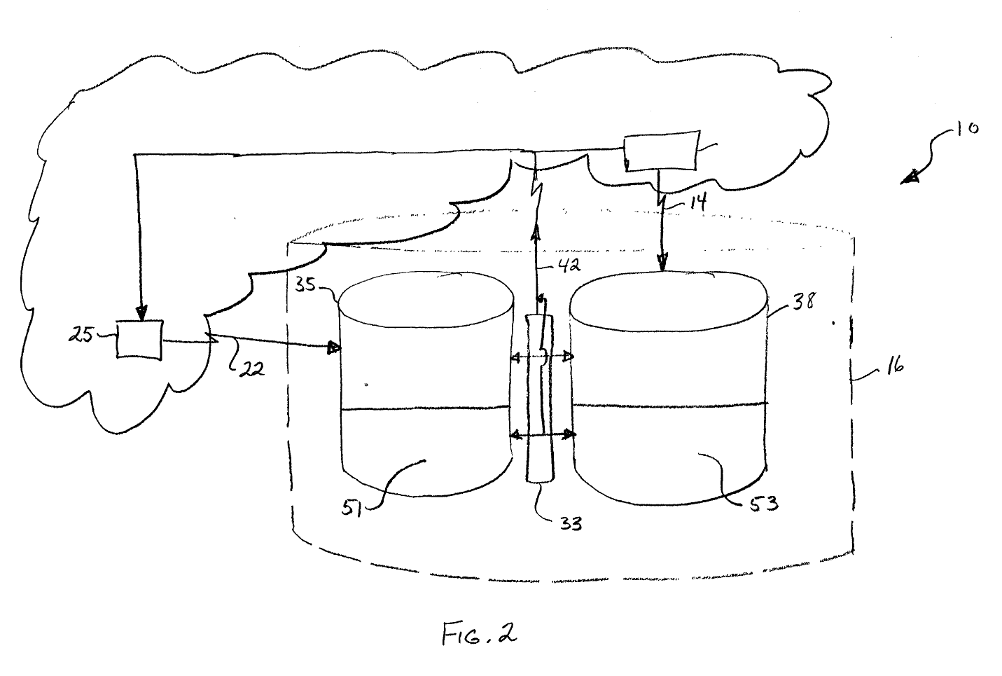

In one example, which is only provided for illustration rather than limitation, a user visiting Washington, D.C. may desire to extend her hotel stay after already checking out of her previous hotel. This invention would be quite useful, particularly if the user were busy with meetings. She may then use her cellular phone to access system 10. Her prior registration with a service provider may have been entered through her phone or another data portal (using a communication means) and may have included a preference for a non-smoking queen size bed in a certain prioritized ranking of hotels or hotel chains or hotel types. She might even designate the type of bed or other feature desired. Her prior registration may also have included the best-fit data of a service within a distance or time of the caller's location at the time of the call. Alternatively, a best-fit analysis may include a bidding bot option and data configuration (shown in FIG. 2 as elements 51 for services and 53 for user needs which are designated for bidding operations) to actually bid for biddable hotel rooms in a prioritized manner, when such rooms are not already listed as available. Yet another option may include a location match to find the optimum location according to various user or environmental parameters.

In this example, the reservation data sorter had been receiving constantly updated data transmissions from registered service providers in numerous locations. When the caller communicated with the data sorter, system 10 automatically identified the caller and the caller's location through cell phone identifier or other known means, possibly including query means. Virtually simultaneously, the data sorter also queried the data within the system at the time of the service request and provided best-fit data matching the services available to the user's desires and location. A reservation number was instantly validated with the service provider and communicated directly to the caller—concluding and confirming the reservation transaction. Voice or other means may then activate credit card or other payment information for transfer or qualification of that information to reserve the service.

The entire process will be very rapid, may take less than one minute, and indeed preferably ought to take less than 10 seconds. In other words the process should be very brief, such as from about a few seconds to about a few minutes—but ideally less than about 30 seconds. Service providers may include hotel associations, hotels, hotel chains or restaurants. Other providers may include regional or local business or tourist organizations, municipalities, travel agencies, airlines, trade associations, and online or other travel guide providers or publishers, as well as others in need of such technology. This may even include industry consortiums or other service providers. Indeed, fees for this service might even be payable by the service providers or subscribers, and allow the users of this single point instant wireless reservation system to communicate with the system 10 without charge. Alternatively, certain charges may be billable to the user. For example, certain subscribers may require a portion of a charge. In another example, if the user decides to employ a biddable option on a service, as will be discussed further herein below, then a certain fee may be charged. Charges for services may be automatically attributable to the appropriate account according to user or subscriber agreement. Use of verification techniques such a code word or voice analysis may allow further efficiencies during the call 18, and would also provide requisite security for such transactions and confirmation of length of stays or similar particularly relevant data according to the characteristics of the service.

This model recognizes that users (and service subscribers or providers) will often migrate to the simplest and most reliable form of communications. Some of the advantages of this system derive from the ease afforded the traveler by making only one very short-duration phone call, and in some embodiments not even requiring access to a computer or any other non-phone connection to the Internet, World Wide Web or other source of service data. Further advantages include higher efficiencies for service providers, including improved access to travelers and higher utilization rates of their services. Another advantage is to ensure that service providers consisting of large affiliated companies will qualify to function under anti-competitive guidelines due to the availability of this invention as a service option to the user/consumer.

These and other advantages are all achievable by use of a constantly updated system of availability of services throughout one or more vast and integrated networks of service providers, and an algorithmic or other means for rapid matching of the prioritized service(s) needed by a user, and confirming the availability with the specific user's location all within an extremely short time from when the user accesses the system. Certain embodiments may be available for arranging future trip options in different locations in order to provide templates, defaults or other types of pre-sets to the system according to locale, time of year, number of guests accompanying the user or other parameters. These embodiments may use either phone or other communication means to establish or adjust user preferences and profiles.

Additional features may include biometrics means for rapid identification of the user through voice recognition and/or voice generation capabilities, thus automating the rapid validation and payment processes of a user. Moreover, the system is able to provide ease of selection or alteration of the range to the service that is available (i.e. distance to nearest available hotel or time which the user is willing to wait in order to receive access to a service) by either voice, key or phone number pad direct entry. In this example, a voice analysis or recognition capability is more readily adaptable in view of the phone interface already being suitable for aural input and use as compared with other mediums.

Yet another feature of this system 10 allows for readily available access to current travel or other service information to every user at any time. For example, a user may be reading an online Internet or similar publication or electronic book and may wish to obtain a reservation for travel. This system allows for great ease of access to the available services in a location mentioned in the particular article or e-book being read. An embedded link to the location may connect with this service to allow the reader/user to connect to system 10 reservation data sorter 16 while maintaining their position in their reading material. The overall efficiencies of such a system for travelers will greatly aid in their selection of services. This feature may include a query-only option to allow a user to merely inquire about a service rather than to obtain an instant prioritized reservation.

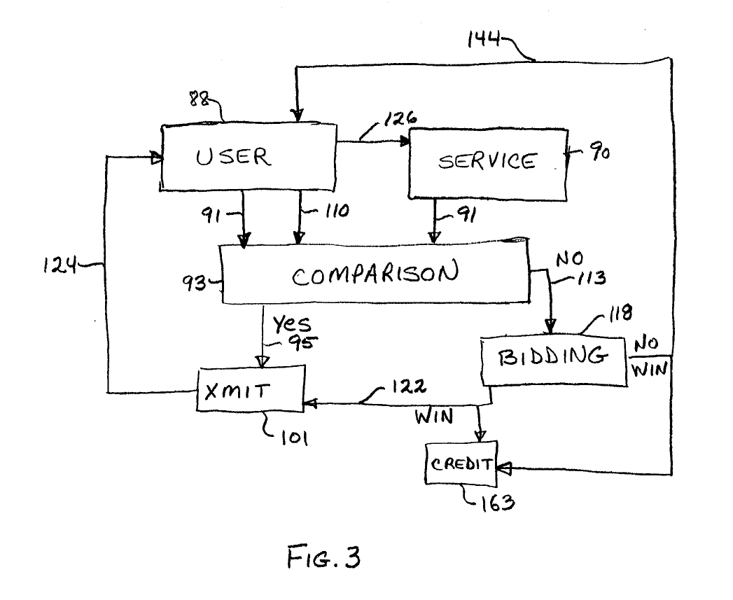

FIG. 3 illustrates the method of the invention in which user preferences 88 and service availabilities 90 are communicated 91 in a time cycle according to the rate of change of either in order to maintain current data in as near to real time as possible. The information is communicated 91 to a database or other comparison subsystem 93 to ascertain best fits of data for transmission upon demand, likely by user action. If a match of the services and needs occurs, the appropriate match validating information is noted 95 and prepared 101 for transmission 104 to user when appropriate. A user accept/reject path 110 may also be appropriate. If a match is not possible, such as at path 113, then further analysis is performed at step 118 at which a bidding operation as described herein is performed to identify a biddable service to match the needs of the user and to commence or request authority to commence bidding operations. If a match is then found, the information is again delivered 122 for formatting and transmission to the user, and the service provider (such as at path 126 or through other channels of reciprocal information sharing). Alternatively, if bidding operations fails to achieve a match or acceptable best fit according to the input criteria of the user and service providers, then appropriate communication 144 is sent to the user. In either a win or loss in a bidding operation between multiple users bidding for the identical service then a reward or credit is generated according to defined rules at 163 and is transmitted to an appropriate repository for the users involved.

Accordingly, as noted above, the invention also includes a bidding bot option to actually bid for biddable hotel rooms in a prioritized manner, when such rooms are not already listed as available. This biddable option would allow users to automatically attempt to obtain their preferred service choice, even though there was no initial availability or for other reasons, by attempting to outbid the then current reservation holder for that service. Alternatively the system may automatically command a bidding option, i.e., a bidding bot, either up or down in price with the service provider or its agent, responsive to certain pre-set or other conditions. In this embodiment, the provider of the service would allocate a certain block or amount of services to be eligible for bidding. Then, according to agreed-upon bidding rules, a user could automatically bid a higher price to pay or other parameter (e.g. length of stay, etc.) for the service. Certain scenarios may allow for the biddable option to expire after a certain price or other parameter or milestone is achieved. For example, if a biddable hotel room reached a level of three times it's normal price during a bidding mechanism, then the user whose bid reached that level first might then qualify for removal of the biddable option in order to be able to rely on that reservation becoming permanent again to that successful high bidder. Allowing for biddable services may be regulated in order to prevent abuse or unfair practices. Certainly, though, the biddable option for services greatly enhances the ability of a service network to accommodate over-saturation of users, according to whatever rules it adopts other than first come- first served, as is the normal rule for most services. Use of biddable options for services may actually create increased customer or user loyalty through creative bonus or reward systems for both the successful and the unsuccessful bidders.

Accordingly, this invention enables another novel business method for real-time bidding among potential users of a service. Although a lodging industry service is used as an example, the invention applies to various industries and services. In the lodging industry it may be possible for a service provider to withhold or optionally designate a certain number of hotel rooms and related services for qualified bidding according to certain rules. For example, if user #1 had a reservation for a biddable hotel room, and user #2 wanted to pay a greater incremental amount than user #1 for that room for the same or overlapping time period, then user #2 could obtain the preferential right to the room, subject to certain fair trade rules. The bidding would occur automatically without the users being involved. In exchange for being outbid, user #1 might receive nothing further or he might receive credits, discounts or other items of value—including automatic alternate booking and notification or preferential bidding rights in the future. However, user #2 might also face a bidding scenario against a user #3, subject to agreement, unless a maximum bid, surcharge, or other qualification by user #2 was met. Moreover, it may be possible with this invention for the hotel service provider to allow bidding credits to frequent users of the hotel or those users with a higher spending profile per stay at the hotel. These business methods optimize utilization of services by exploitation of the instantaneous reservation system and methods disclosed herein, while also providing valuable services to users of the invention never experienced before.

In addition to the data and the data flow discussed above, there are various new uses for this technology which occur as a result of the underlying inventions disclosed herein. Generally, the technical innovations referred to herein create knowledge enhanced value, integration enhanced value, utilization enhanced value, and timing enhanced value. These value enhancements in turn enable previously unknown services and products to be provided to various consumers, such as service providers, travelers, business people, and others. When previously inaccessible or non-useable information of high relevance regarding user desires and service availabilities is rendered instantly available and in appropriate structure or format, then the above technical effects, advantages, and contributions are made possible. As such, the technical advantages and contributions of Applicants is realized.

While the invention has been described herein using the examples of hotel room, restaurant, automobile or other travel, and similar services, it is understood that the invention may have broader applications to other services, including location-based services, requiring a prompt or changeable reservation. For example, this may include online access to another service, and the below-listed claims are written inclusively to encompass such broad possible applications consistent with the prior art, as it may apply.

The invention thus relates to multiple types of technologies integrated to support an infrastructure of network communications for optimizing the use of available services and user needs, with great speed and accuracy. Indeed, this unique combination of technical features enables highly innovative outcomes in the form of instantaneous service matching, bidding operations, credits to users, loyalty enhancing user packages, and user assurance improvement. Overall system efficiency is improved as well through use of this new advance in information and communication technology utilization. This invention contemplates various technical means and systems and various types of methods to achieve previously unattainable goals. It is believed that these innovations and technical contributions provide a powerful combination of features and service advantages in view of the previously stated challenges to real-time effective management of user needs in the service industry, and that this has not been accomplished or realistically contemplated before by others.

What is claimed is:

1. A system for automatic optimizing and rapid booking of reservations for services, comprising:
a. a reservation data sorter for constantly monitoring, receiving and sorting electronic data signals comprising information describing service availability for selected services from service providers;
b. a communication subsystem for allowing a user of the system to be identified and located by the system, access the system, and for the reservation data sorter to communicate with the user; and
c. a comparison subsystem for comparing the prioritized needs of a user accessing the system with the availability of the service, thereby enabling and providing a rapid optimized and prioritized reservation at any time the user communicates with the system.

2. The system of claim 1 in which the reservation data sorter comprises at least one data server.

3. The system of claim 1 in which the communication subsystem comprises a cellular phone for use by the user of the system and a communications interface at the reservation data sorter.

4. The system of claim 1 in which the communication subsystem comprises a phone for use by the user of the system and a communications interface at the reservation data sorter.

5. The system of claim 1 in which the communication subsystem comprises an electronic interface for use by the user of the system and a communications interface at the reservation data sorter.

6. The system of claim 1 in which the comparison subsystem comprises a software algorithm for sorting streams of signal data and identifying the available services which match a preference set of services identifiable to a specific user.

7. The system of claim 6 in which the comparison subsystem further comprises software for constantly prioritizing and matching the available services and user preferences, with the software thereby creating a constantly updated user file which is assemblable for communication to a user upon access to the system by the user.

8. The system of claim 1 in which the reservation data sorter and the communication subsystem comprise interfaces which enable communication of reservation information to a user in less than one minute following connection of the user to the system.

9. The system of claim 1 in which the reservation data sorter and the communication subsystem comprise interfaces which enable communication of reservation information to a user in less than 45 seconds following connection of the user to the system.

10. The system of claim 1 in which the reservation data sorter and the communication subsystem comprise interfaces which enable communication of reservation information to a user in less than 30 seconds following connection of the user to the system.

11. The system of claim 1 in which the reservation data sorter and the communication subsystem comprise interfaces which enable communication of reservation information to a user in less than 15 seconds following connection of the user to the system.

12. The system of claim 1 in which the communication subsystem comprises biometrics identification means for identifying the user.

13. The system of claim 1 in which the communication subsystem comprises biometrics identification means for interfacing with the user.

14. The system of claim 1 in which the comparison subsystem comprises interface means for cooperating with the reservation data sorter to activate a bidding operation with at least one provider of services desired by the user.

15. The system of claim 14 in which the bidding operation is automatically activated when certain conditions are met.

16. The system of claim 14 in which the bidding operation is electively activated by the user of the system.

17. A system for automatic optimizing and rapid booking of reservations for services, comprising:
a. at least one reservation data sorter for receiving and sorting electronic data signals comprising information describing service availability for selected services;
b. a communication subsystem for allowing a user of the system to access the system and for the reservation data sorter to communicate with a user of the system;
c. a comparison subsystem for comparing the needs of a user accessing the system with the availability of the service in order to achieve an optimum reservation preference at any time the user communicates with the system; and
d. a bidding subsystem cooperating with at least the reservation data sorter for bidding for services from a service provider; wherein the user will receive optimized reservations by bidding to a pre-selected level for services made available subject to bidding operations.

18. The system of claim 17 in which the system provides alerts to the user of bidding options or levels.

19. The system of claim 17 in which the bidding operation is automatically activated when certain conditions are met.

20. The system of claim 17 in which the bidding operation is electively activated by the user of the system.

21. A business method for constantly providing instant service reservations upon user demand regardless of location, comprising the steps of:
a. implementing data transmission and handling agreements to receive electronic data signals from service providers and to allow instant reservations services and constant updating of the data transmitted;
b. providing at least one reservation data sorter configured for constantly receiving and sorting electronic data signals comprising information describing real-time service availability for selected services;
c. configuring communication means for allowing a user of the system to access the system using telephone, a personal digital assistant, or other electronic means for communicating, and for the reservation data sorter to communicate with the user; and
d. providing a comparison subsystem for comparing the service needs of a user accessing the system with the current availability of the needed service in order to achieve an optimum reservation preference at any time and at any location the user communicates with the system and to communicate a confirmed optimum reservation preference to the user during the same telephone call that was initiated by the user.

22. The method of claim 21 in which the step of providing a comparison subsystem includes providing software and algorithms for sorting streams of signal data and identifying the available services which match a preference set of services identifiable to a specific user.

23. The method of claim 21 in which the step of providing a comparison subsystem includes providing software for constantly prioritizing and matching the available services and user preferences, with the software thereby creating constantly updated user file elements which are location dependent and rapidly assemblable for communication to a user upon access to the system by the user.

24. The method of claim 21 in which the reservation data sorter and the communication subsystem comprise interfaces which enable communication of reservation information to a user in less than one minute following connection of the user to the system.

25. The method of claim 21 in which the reservation data sorter and the communication subsystem comprise interfaces which enable communication of reservation information to a user in less than 15 seconds following connection of the user to the system.

26. The method of claim 21 in which the communication subsystem comprises biometrics identification means for identifying the user.

27. The method of claim 21 in which the communication subsystem comprises biometrics identification means for interfacing with the user.

28. The method of claim 21 in which the step of providing a comparison subsystem comprises the step of coordinating the reservation data sorter to activate a bidding operation with at least one provider of services desired by the user.

29. The method of claim 28 in which the step of configuring a communicating subsystem comprises the step of activating means for providing alerts to the user of bidding options or levels.

30. The method of claim 28 in which the step of configuring a communicating subsystem comprises the step of providing digital or aural alerts to the user of bidding options or levels.

31. The method of claim 30 in which the step of transmitting digital or aural signals to a user includes the step of transmitting a voice communication in a voice that is pre-selected and customized for the particular user.

32. An accessible electronic memory configured for storing, accessing and deleting rapidly changing data by an application program being executed on a data processing sub-system, comprising:
a. a data structure stored in an electronic memory, said data structure including information resident in a database used by an application program and including:
b. at least one identifying characteristics data file set stored in said memory, each of said data file set(s) containing information unique to a specific user;
c. at least one preference data file set stored in said memory, each of said data file set(s) containing information relating to service preferences of a specific user; and
d. a plurality of data files containing constantly updated service availability data from a plurality of service providers; wherein the data structure and manipulation is configured to allow rapid access to the preference data file and the service availability data files to conduct comparison operations with at least one identifying data file set suitable for location-dependent service needs of the user.

33. The memory of claim 32 in which the application program is executable by use of a telephone.

34. A data processing system executing an application program and containing a database used by said application program, said data processing system comprising:
a. a processing subsystem for processing an application program; and
b. electronic memory means configured for storing and deleting rapidly changing data accessible by said application program, comprising:
a data structure stored in said memory means, said data structure including
information resident in a database used by said application program and including:
at least one identifying characteristics data file set stored in said memory means, each of said data file sets containing information unique to a specific user;
at least one preference data file set stored in said memory means, each of said data file sets containing information relating to service preferences of a specific user;
a plurality of data files containing constantly updated service availability data from a plurality of service providers;
c. wherein the data structure allows rapid access to the preference data file and the service availability data files to conduct comparison operations with at least one identifying data file set suitable for location-dependent service needs of the user.

35. A computer data signal embodied in a transmission medium comprising:
a. a registration source code corresponding to a unique, location-dependent, service availability and useful for confirming assignment of a specific service to a requester of that service; and
b. a carrier medium suitable for carrying the registration source code to a location and configured so that the registration source code is retrievable from the carrier medium for retention by the user if the specific service is obtained by the user.

36. A business method for constantly providing instant service reservations upon user demand regardless of location and maximizing use of service provider services, comprising the steps of:
a. implementing data transmission and handling agreements to receive electronic data signals from service providers and to allow instant reservations services and constant updating of the data transmitted;
b. providing at least one reservation data sorter configured for constantly receiving and sorting electronic data signals comprising information describing real-time service availability for selected services;
c. configuring communication means for allowing a user of the system to access the system using telephone, a personal digital assistant, or other electronic means for communicating, and for the reservation data sorter to communicate with the user; and
d. providing a comparison subsystem for comparing the service needs of a user accessing the system with the current availability of the needed service in order to achieve an optimum reservation preference at any time and at any location the user communicates with the system, and to utilize the step of activating means for providing either automatic or selective bidding operations with the service provider to ensure the needs of the user and the service provider are met and to communicate a confirmed optimum reservation preference to the user during the same telephone call that was initiated by the user.

37. The method of claim 36 in which the bidding operations include the assignment of bonus or other reward credits to a loser and a winner of a bidding operation.

38. The method of claim 36 in which the bidding operations include the assignment of quantitative bidding credits to one or more parties engaged in a bidding operation based on prior or committed spending profiles of each bidder in relation to the service involved in the bidding operation or a designated affiliate service.

39. A computer implemented network-enabled system configured for implementing the method of automatically determining which connection protocols to follow to rapidly connect one or more remote persons to a database network for rapid data exchange and analysis, said system being characterized in that it comprises:
a. at least one reservation data sorter for receiving and sorting electronic data signals comprising information describing service availability for selected services;
b. a communication subsystem for allowing a user of the system to access the system and for the reservation data sorter to communicate with a user of the system;
c. a comparison subsystem for comparing the needs of a user accessing the system with the availability of the service in order to achieve an optimum reservation preference at any time the user communicates with the system; and
d. a bidding subsystem cooperating with at least the reservation data sorter for bidding for services from a service provider; wherein the user will receive optimized reservations by bidding to a pre-selected level for services made available subject to bidding operations.
